(19) United States
(12) Patent Application Publication
(10) Pub. No.: US 2026/0369448 A1
(43) Pub. Date: Nov. 19, 2026

(54) BUSHING COMPRISING A CONNECTION TERMINAL, AND SHEET-METAL HOUSING AND RELAY COMPRISING SUCH A BUSHING

(71) Applicant: SCHOTT AG, Mainz (DE)

(72) Inventor: Helmut HARTL, Landshut (DE)

(21) Appl. No.: 19/158,795

(22) PCT Filed: Feb. 28, 2024
(86) PCT No.: PCT/EP2024/055025

§ 371 Date: Aug. 21, 2025

(30) Foreign Application Priority Data
Mar. 13, 2023 (DE) 10 2023 106 157.7

(51) Int. Cl. H01B 17/58; H01B 17/30; H01H 50/02; H01H 50/14; H01H 50/54

(52) U.S. Cl. CPC H01B 17/583; H01B 17/305; H01H 50/023; H01H 50/14; H01H 50/546

(57) ABSTRACT

A bushing having a connection terminal for a high-power relay is provided having a housing part having a through opening, and a connection terminal arrangement fed through the through opening and sealed by a fixing material. The bushing has a reinforcing component for the through opening of the housing part. The glazing length of the fixing material is greater than the thickness of the housing part. The connection terminal arrangement includes a connection terminal and a tube guide which surrounds at least part of the connection terminal. There is a first gap between an inner wall of the sleeve section and the connection terminal, and the connection terminal arrangement includes a flexible element via which the tube guide is connected to the connection terminal. A housing and a relay including a bushing is also disclosed.

The invention relates to a bushing having a connection terminal, in particular for a high-power relay, the bushing comprising a housing part, which has a through-opening, and a connection terminal assembly, which is inserted through the through-opening and which is sealed against the through-opening by means of a fixing material. Further aspects of the invention relate to a housing and a relay, which each comprise at least one such bushing.

Relays used to switch electric currents on and off are known in the prior art. An example of these are high-power relays used in electric vehicles or hybrid vehicles to safely disconnect a traction battery, which provides the electrical energy for the vehicle, from an electrical system of the vehicle. Such a relay comprises a housing, electrical bushings for the circuit to be switched, and a contacting device, which connects or disconnects two terminals in order to switch the current. The contacting device can be actuated by means of an actuator, for example in the form of an electromagnet. The interior of the housing is usually sealed to prevent the ingress of moisture and to keep within the housing any quenching gas present in the housing for quenching an arc.

EP3358593 B1 discloses a hermetic terminal which is suitable in particular for a high-power relay. The hermetic terminal comprises: a metal container provided with a through hole; a pipe lead inserted through the through hole; an insulating glass hermetically sealing the pipe lead and the metal container; and a terminal base passing through and hermetically secured to the pipe lead. The terminal base is made of a low-resistance metal and is arranged in the terminal such that a gap is provided between an inner circumferential surface of a portion of the pipe lead in contact with the insulating glass and an outer circumferential surface of a corresponding portion of the terminal base. In the event of thermal expansion of the terminal base, the pipe lead deforms so that damage to the insulating glass is avoided.

EP 4 002 415 A1 discloses a hermetic terminal element and a contact device having such a terminal element. The terminal element comprises a container having through-openings, into each of which a pipe lead is inserted, said pipe lead forming, together with an insulating glass, a glass-metal bushing which is hermetically sealed against the metal container. The pipe lead is connected, by means of a weakened portion, to a terminal base inserted into the pipe lead. The weakened portion can be made of a different material than the rest of the pipe lead or can be a thin portion of the pipe lead.

In the known bushings, the flexibility needed to compensate thermal expansion of the connection terminal is provided by the pipe lead, which must have a minimum length or minimum height for this purpose. Therefore, the known bushings have a relatively large construction height. Furthermore, for the implementation of a glass-metal bushing it is necessary that the housing part is sufficiently stable and thick in order to provide a hermetically tight glazing able to withstand mechanical loading. In order to be able to implement housings with such bushings such that they are more compact overall, an object of the invention is to provide a bushing having a connection terminal, said bushing having a small construction height and being mechanically stable and tight even in the case of thin-walled housings.

The known pipe leads must be elastic in order to be able to absorb length changes due to thermal expansion of a connection terminal. However, if a pressure glazing is desired for hermetic sealing, the counterpressure necessary for this purpose cannot be applied by the known pipe leads. Furthermore, the housing material must also have an appropriate wall thickness in order to be able to exert sufficient pressure for the pressure glazing. Accordingly, an object of the invention can be regarded as that of providing a bushing which is suitable for a pressure glazing when a thin-walled housing is used.

If screw connections are used between a connection terminal and a supply line, high torques which cannot be optimally absorbed by the known hermetically sealed connection terminals can occur during the tightening of the connection screws. Accordingly, another object of the invention can be regarded as that of providing a bushing having a connection terminal, in which bushing the absorbing and transferring of torques introduced at the connection terminal is improved.

### DISCLOSURE OF THE INVENTION

A bushing having a connection terminal is proposed, the bushing being suitable in particular for a high-power relay. The bushing comprises a housing part, which has a through-opening, and a connection terminal assembly, which is inserted through the through-opening and which is sealed against the through-opening by means of a fixing material. The bushing also has a reinforcing component, which reinforces the housing part in the region of the through-opening, and a glazing length EL of the fixing material is larger than the thickness of the housing part. The connection terminal assembly comprises a connection terminal made of a first material and a pipe lead made of a second material, wherein the pipe lead surrounds at least part of the connection terminal and the fixing material is arranged between an outer wall of a sleeve portion of the pipe lead and an inner wall of the through-opening in order to seal the connection terminal assembly, wherein a first gap is present between an inner wall of the sleeve portion and the connection terminal. The fixing material mechanically fixes the connection terminal assembly in the through-opening and electrically insulates the connection terminal assembly from the housing part. The connection terminal assembly also comprises a flexible element, by means of which the pipe lead is connected to the connection terminal, wherein the flexible element surrounds a pin portion of the connection terminal, and wherein a second gap is present between the pin portion of the connection terminal and the flexible element. In a first variant i), the flexible element is formed integrally with the pipe lead as a portion of the pipe lead with reduced thickness. In a second variant ii), the flexible element is made of a third material. In a third variant iii), the flexible element is formed integrally with the connection terminal.

The connection terminal has a pin portion which serves, in particular, as a current conductor in the bushing. The pin portion is preferably essentially cylindrical, in particular in the shape of a circular cylinder, but other shapes are also conceivable. For example, cylinder shapes having an oval, rectangular or square cross section are also conceivable. It would also be conceivable for the pin portion to be completely or partly conical. The pipe lead having the sleeve portion and the flexible element surround the pin portion at least partly. Their cross-sectional shape is preferably selected according to the cross-sectional shape of the pin portion.

In the first variant of the invention, the elasticity of the part of the pipe lead serving as the flexible element is increased by a reduction of the thickness. This reduction of the thickness is in particular in relation to the sleeve portion, such that a thickness, in particular a wall thickness, of the pipe lead in the region of the flexible element is smaller than the thickness in the region of the sleeve portion.

In the second variant of the invention, the elasticity of the flexible element is increased by virtue of the fact that the flexible element is made of another material. The third material is preferably selected such that its modulus of elasticity is smaller than the modulus of elasticity of the second material of the pipe lead. As a result, even if the flexible element has the same wall thickness as the pipe lead in the sleeve region, the elasticity is increased. However, a thickness or wall thickness of the flexible element can of course additionally also be selected to be smaller than the thickness of the pipe lead in the sleeve region in order to increase the elasticity even further.

In the third variant, the flexible element is formed integrally with the connection terminal and thus is made of the same material as the connection terminal. The first material of the connection terminal usually has a smaller modulus of elasticity than the second material of the pipe lead. A thickness or a wall thickness of the flexible element can also be selected independently of the thickness of the sleeve portion of the pipe lead, so that a flexible element having good elastic properties is obtained. In particular, the thickness or a material thickness of the flexible element can be selected to be smaller than a thickness of the pipe lead in the sleeve portion.

In comparison with the bushings known from the prior art, all three variants allow the flexibility of the flexible element to be set independently of the properties of the sleeve region of the pipe lead and make it possible to reduce the length of the flexible element, resulting in a reduction of the construction height of the bushing. The construction height is understood to be, in particular, the length by which the connection terminal assembly protrudes beyond the housing part. Furthermore, the reinforcing component allows the proposed bushing to be used also in the case of housing components with small thickness d, while nevertheless obtaining high mechanical stability and a safe and hermetically tight bushing. This is advantageous in particular in the case of housing components in the form of sheet-metal parts.

The flexible element is connected to the connection terminal or to the pipe lead preferably by means of welding or soldering.

This connection is preferably hermetically tight. Likewise, the sealing between the pipe lead and the inner wall of the through-opening by means of the fixing material is preferably hermetically tight.

“Hermetically tight” is understood to mean, in particular, that at a pressure difference of 1 bar the helium leakage rate is less than 1·10⁻⁸ mbar l/s⁻¹, preferably less than 1·10⁻⁹ mbar l/s⁻¹.

To obtain a tight bushing, a sufficiently large glazing length EL is re-quired. Seen along the longitudinal axis of the through-opening, the glazing length is the length along which the fixing material is connected to the reinforced housing component and touches the housing component and optionally the reinforcing component. Without further measures, the thickness d of the housing component would correspond to the glazing length EL.

In order to save material and thus weight and volume, it is desirable to select the thickness d of the housing part to be as small as possible. Furthermore, in the case of small material thicknesses it is possible to design the housing part as a sheet-metal part and to bring it easily into the desired shape by forming methods such as deep drawing. Here, “thickness d” refers to the material thickness of the housing part, in particular when it is designed as such a sheet-metal part. If the housing part has a variable material thickness, the thickness d relates to the material thickness of the housing part in the region of the through-opening.

In order to extend the glazing length EL, it is preferred that the reinforcing component is designed and arranged such that it extends an inner wall formation of the through-opening and provides the glazing length EL together with the housing part. In this case, a wall formation of the reinforcing component adjoins and extends the inner wall formation of the through-opening, and the fixing material is directly in contact with the reinforcing component and is preferably glazed onto the reinforcing component.

Alternatively, the housing part can be bent in the region of the through-opening in order to form the inner wall formation of the through-opening over the entire glazing length, the bent portion of the housing part being supported by the reinforcing component. For this purpose, for example the material of a housing part designed as a sheet-metal part can be shaped and, for example, bent at an angle of approximately 90°. The fixing material is in direct contact with the housing component over the entire glazing length and does not touch the reinforcing component. The reinforcing component is preferably designed such that it directly touches and supports the bent portion of the housing component.

The reinforcing component is preferably connected to the housing component by means of a joining method such as soldering, welding or adhesive bonding.

The material thickness d of the housing part is preferably in the range of 0.5 mm to 1 mm. The glazing length EL, which should be larger than the material thickness d of the housing part, is preferably in the range of 1.5 mm to 3 mm in order to allow a hermetically tight connection which can withstand mechanical loading. Accordingly, a thickness D of the reinforcing component in the range of 0.5 mm to 2.5 mm is preferably selected.

The connection terminal preferably has at least one collar. The collar is formed, in particular, as a region of the connection terminal within which an outside diameter of the connection terminal is enlarged in comparison with an outside diameter in the pin portion. Such a collar can have a constant diameter. However, the diameter can also change abruptly in one or more steps or continuously in the region of the collar.

The at least one collar is preferably arranged on the connection terminal in such a way and dimensioned in such a way that the collar is arranged outside the through-opening.

The flexible element according to variant i) or ii) is preferably connected to the collar on a side of the collar facing the through-opening. If the flexible element is formed integrally with the connection terminal, according to variant iii), it is preferred if the portion of the connection terminal that forms the flexible element begins on the side of the collar facing the through-opening.

The outside diameter of the collar and the outside diameter of the flexible element can be selected to be identical, so that the flexible element adjoins the collar in a flush arrangement. Alternatively, the outside diameter of the flexible element can be selected to be smaller.

As an alternative to arrangement of the flexible element on a face of the collar facing the through-opening, the flexible element according to variant i) or ii) is preferably connected to the collar at a lateral face of the collar.

The connection terminal can comprise connection means on one or both end faces in order to facilitate the connection of an electrical supply line. These connection means are, for example, in the form of a threaded bore which allows a screw connection with an electrical connection. Such a threaded bore is preferably provided at least on one outward-facing side of the bushing.

However, the connection means can alternatively also, for example, be in the form of a flat face suitable for a solder connection or weld connection. In this context, the surface may coated and/or roughened so that such connections exhibit better adhesion.

The pipe lead or the flexible element, if formed integrally with the pipe lead, can comprise a flange in order to simplify the connection to the connection terminal, in particular to the collar of the connection terminal. For this purpose, a wall formation of the pipe lead can be folded to form a flange, or an end surface of the pipe lead can be enlarged by adjusting the outside diameter and/or the inside diameter.

By providing such a flange, a diameter of a connection point can also be enlarged, whereby torques acting on the connection terminal can be better transferred at the connection point without damage.

If the flexible element is not formed integrally with the pipe lead, it is preferred that the pipe lead has a continuous or abrupt enlargement of the diameter on a side facing the flexible element, outside of the through-opening, and the pipe lead is connected to the flexible element in this region with enlarged diameter. In this case as well, the resulting enlarged diameter can improve the transfer of torques acting on the connection terminal, so that, in particular in the case of the connection of a connection cable to the connection terminal by screwing, the bushing does not suffer damage.

The flexible element is preferably arranged and designed such that the second gap between the flexible element and the pin portion is larger than or just as large as the first gap between the sleeve portion and the pin portion. If, for example, the flexible element is formed by extension of the pipe lead with reduced wall thickness, the reduction of the thickness is preferably accomplished by enlarging the inside diameter and maintaining the outside diameter.

In particular if the bushing is provided for an electrical connection with high voltages of in particular more than 100 V and particularly preferably more than 1000 V, an insulation distance provided by the fixing material is preferably extended by the arranging of additional insulation material. In this way it is possible to reduce in particular the occurrence of creepage currents and/or flashovers which otherwise, when soiling and/or moisture is present, could overcome the insulation distance provided by the fixing material alone.

For this purpose, the fixing material and an adjoining portion of the housing part are preferably covered with an insulation material on a top side and/or on a bottom side of the bushing.

The insulation material can be in the form of an insulation disk composed of electrically insulating material. Alternatively or additionally, the insulation material can be in the form of a coating, in particular with a potting compound, composed of an electrically insulating material.

In the case of implementation as an insulation disk, the insulation material can be selected in particular from a glass, a glass ceramic, a ceramic or a plastic; plastics are preferred. The insulation material could also be selected to be identical to the fixing material.

The bushing is preferably designed as a pressure glazing, in the case of which a coefficient of thermal expansion of the housing part and/or of the reinforcing component is greater than a coefficient of thermal expansion of the fixing material. The coefficients of thermal expansion of the reinforcing component and of the housing part are preferably matched to each other, but they can also be selected to be different. The arranging of the reinforcing component is particularly advantageous, because, to form the pressure glazing, compressive forces must be transferred to the fixing material, and thin-walled housing components without reinforcement do not have sufficient mechanical strength. The fixing material, which here is preferably a glass, is then provided, for example, as a pressed part made of glass powder and is inserted, together with the connection terminal assembly or at least together with the pipe lead, into the through-opening of the housing part. By heating this assembly, the fixing material is obtained from the pressed part and glazes onto the wall formations of the through-opening and of the pipe lead. During cooling, the housing part and/or the reinforcing component then contracts more greatly than the fixing material due to the selection of the coefficients of expansion, so that, in the finished bushing, the housing part and/or the reinforcing component continuously exerts pressure on the fixing material. This has the result, in particular, that the sealing is of high quality and lastingly remains tight and in particular remains hermetically tight even under difficult conditions such as frequent temperature cycles and high mechanical demands. The pipe lead is designed and implemented such that the fixing material in this pressure glazing is supported from the inside. For this purpose, the sleeve portion has a thickness which is selected in combination with the material selection of the pipe lead such that the sleeve portion can apply a sufficient counterpressure.

For an implementation as a pressure glazing, the material of the housing part or of the reinforcing component and the fixing material are preferably selected such that a coefficient of thermal expansion of the housing part and/or of the reinforcing component, α_{housing}, is at least 20% greater than a coefficient of thermal expansion of the fixing material, α_{glass}. For example, α_{housing} is selected in the range of 12·10⁻⁶ 1/K to 19·10⁻⁶ 1/K and α_{glass} is selected in the range of 9·10⁻⁶ 1/K to 11−10⁻⁶ 1/K. Where reference is made to the coefficient of thermal expansion in the present application, this is understood to mean the linear thermal expansion coefficient a in the range of 20 °C to 300 °C.

As an alternative to a pressure glazing, the coefficients of thermal expansion of the housing part, of the reinforcing component, of the fixing material and of the pipe bushing can also be selected to match each other, such that the coefficient of thermal expansion of the fixing material differs from the coefficients of thermal expansion of the housing part or of the reinforcing component and/or of the pipe lead by less than 20%, preferably less than 10% and particularly preferably by less than 5%.

The first material, which is used for the connection terminal, preferably has a smaller electrical resistance than the second material, which is used for the pipe lead. Because the connection terminal is used as an electrical conductor in the bushing, a material having the smallest possible electrical resistance is preferred. This has the result, in particular, that the bushing is not excessively heated even in the case of large currents.

In particular in variants of the bushing in which the flexible element is formed integrally with the connection terminal, it is preferred that the first material has a smaller modulus of elasticity than the second material. As a result, elastic deformation of the flexible element can occur even in the case of relatively large material thicknesses.

If the flexible element is made of a third material and accordingly is in the form of a separate component, the third material for the flexible element according to variant ii) preferably has a smaller modulus of elasticity than the second material of the pipe lead. It is also preferred that the third material additionally has a smaller modulus of elasticity than the first material of the connection terminal.

The first material of the connection terminal is preferably selected from base nonferrous metals such as copper or a base nonferrous metal alloy such as a copper alloy, in particular brass, aluminum or an aluminum alloy.

At least an inward-facing end face of the connection terminal is preferably coated with a contact material in order to reduce the contact resistance and/or to reduce sparking. Optionally, however, both end faces can also be provided with such a contact material. The contact materials are characterized by good resistance to oxidation and are also resistant to wear due to sparks and arcs occurring during switching processes.

Suitable contact materials include, in particular, silver, gold and platinum. Suitable alloys as contact material include, in particular, silver-nickel alloy and silver tin oxide.

The pipe lead is made of the second material. The second material is preferably selected from a steel, in particular a ferritic steel, a steel alloy, in particular nickel steel alloys and chromium steels.

The housing part is preferably made of a metal, and the materials described in relation to the pipe lead are in principle also suitable as the material for the housing part. In addition, other steels, in particular austenitic steels, are also suitable. A material having a coefficient of thermal expansion which is greater than that of the fixing material used is preferred.

In particular in the case of the pipe lead, the second material can also be a composite material constructed of a plurality of layers. However, the selection of a composite material would also be conceivable in principle for a separate flexible element or for the connection pin.

If a separate flexible element is used, the third material is preferably selected from a base nonferrous metal or a base nonferrous metal alloy. Examples of suitable materials include copper, copper alloys, in particular brass.

The pipe lead can be designed as a solid component or can be designed as a folded sheet-metal part. For example, the pipe lead is designed as a sheet-metal part, wherein in the sleeve portion the thickness is enlarged, relative to the portion designed as the flexible element, by folding the sheet-metal part once or multiple times.

The sheet-metal part is preferably a sheet-metal part coated on one side, in which case the sheet-metal part is folded and arranged such that a coated side of the sheet-metal part points toward a connection to the flexible element or to the connection terminal and an uncoated side of the sheet-metal part faces toward the fixing material.

The coating of the sheet-metal part can be, in particular a nickel layer or another layer that facilitates the connecting in particular by means of a soldering process. This is advantageous in particular when the sheet-metal part is made of a steel.

The coated sheet-metal part is preferably always folded and arranged in such a way that the coating does not come into contact with the fixing material. Accordingly, in the region of the sleeve portion the coated side is preferably always on the inside and does not adjoin the fixing material. If the pipe lead is designed with a flange, in the region of this flange the coating preferably faces toward the joining partner. This has the result that the pipe lead can be provided with a weld-connection- and/or solder-connection-promoting surface, even if this surface connects to the fixing material less well. As a result of appropriate folding of the sheet-metal part, the surface best suited for connection to the particular joining partner always adjoins said joining partner.

A pipe lead in the form of a solid component can also be partly coated in order to simplify the joining to the flexible element and/or to the connection terminal in particular in a soldering process. In this case as well, in particular a nickel layer can be used. The coating is preferably applied selectively only to the faces which face the joining partner. In particular, the faces which face toward the fixing material preferably remain free of the coating.

The fixing material both mechanically holds the connection terminal assembly and electrically insulates the connection terminal assembly from the housing part. The fixing material is preferably selected from a glass, a glass ceramic or a ceramic.

The fixing material used is particularly preferably a glass, the glass being selected from a borosilicate glass, a sodium barium glass, an alkali glass, a silicate glass or a soda glass. Borosilicate glasses and sodium barium glasses are especially suited for matched glazings, and alkali glasses, silicate glasses and soda glasses are especially suited for pressure glazings.

An example of the material selection of the bushing is copper as the first material for the connection terminal and a ferritic steel as the second material for the pipe lead. The fixing material used can be, for example, a soda glass.

Here, copper, with approximately 110 GPa, has a lower modulus of elasticity than the ferritic steel of the pipe lead, with approximately 200 GPa. An elastic element made of the copper material of the connection pin can therefore elastically deform even when smaller force is applied, given the same geometry of the elastic element, and thus can absorb the shape change caused by thermal expansion of the connection pin without transferring damaging forces to the fixing material. While maintaining the elasticity of a pipe bushing made of ferritic steel, the dimensions of an elastic element made of copper can accordingly be smaller, allowing the bushing to be more compact.

The connection terminal assembly can also comprise an additional flexible element connected to the pipe lead, the flexible element and the additional flexible element being connected to the connection terminal or, in the case of integral formation, transitioning into the connection terminal on opposite sides with respect to the through-opening.

The additional flexible element likewise is preferably essentially sleeve-like and preferably surrounds the pin portion of the connection terminal at least partly. With respect to the through-opening in the housing part, one of the flexible elements can be oriented toward the top side and the other respective flexible element can be oriented toward the bottom side, so that the connection terminal can be held from both sides of the housing part.

The described bushings are in particular suitable for conducting large currents in the range of several amperes, in particular more than 10 amperes and particularly preferably more than 100 amperes, safely through a hermetically sealed housing.

Another aspect of the invention is the provision of a housing which comprises at least one of the bushings described herein. The housing can be, for example, the housing of an electrical safety device, the housing of a control device such as a relay, or the housing of a battery module.

The housing preferably comprises a deep-drawn component which is formed from a sheet-metal blank and which is part of one of the bushings described herein. The housing part is preferably of a pot-like or cup-like design with a base and side walls. It is preferable to arrange the through-opening(s) for forming one or more bushings in the base. Accordingly, also in the case of the bushing described herein, the use of cup-like housing parts is preferred. As an alternative, however, it is also possible for the housing part to be essentially flat, for example as a cover part for a cup-like additional housing part.

The reinforcing component is preferably annular in order to extend and/or support the through-opening of the housing part.

In another aspect of the invention, a relay comprising a housing, which has at least two of the bushings described herein, and comprising a contacting device for establishing an electrical connection between the connection terminals of the two bushings is proposed.

The contacting device can comprise in particular an actuator which can be controlled by means of an electrical signal, so that current flow between the two connection terminals can be controlled depending on such a control signal. An example of such an actuator is an electromechanical actuator having an electromagnet and having a movable armature. Additionally or alternatively, the contacting device can comprise a pyrotechnical actuator in the case of which an electrical signal can be used to trigger an explosive charge which causes an electrical connection between the two connection terminals to be quickly disconnected. To feed the electrical signals through, the housing can comprise additional electrical bushings.

The housing of the relay is preferably hermetically tight, so that the interior of the housing is protected from environmental influences and nothing can escape from the interior of the housing to the outside. This makes it possible to fill the interior of the housing or at least a region around the contacting device with a so-called quenching gas. The purpose of such a quenching gas is to quench as quickly as possible an arc which can occur when the electrical contact to the connection terminals is ended.

The invention is described in more detail below with reference to the figures and without limitation thereto.

The drawings show:

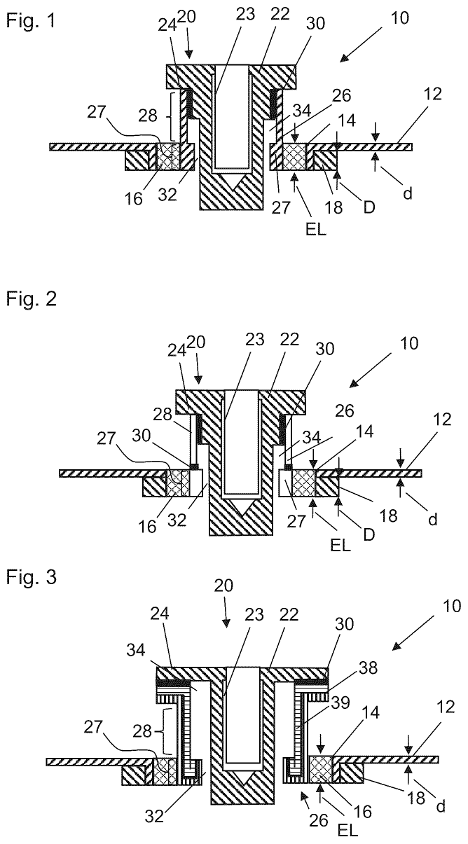

FIG. 1: a first embodiment of the bushing in a schematic sectional view from the side,

FIG. 2: a second embodiment of the bushing in a schematic sectional view from the side,

FIG. 3: a third embodiment of the bushing in a schematic sectional view from the side,

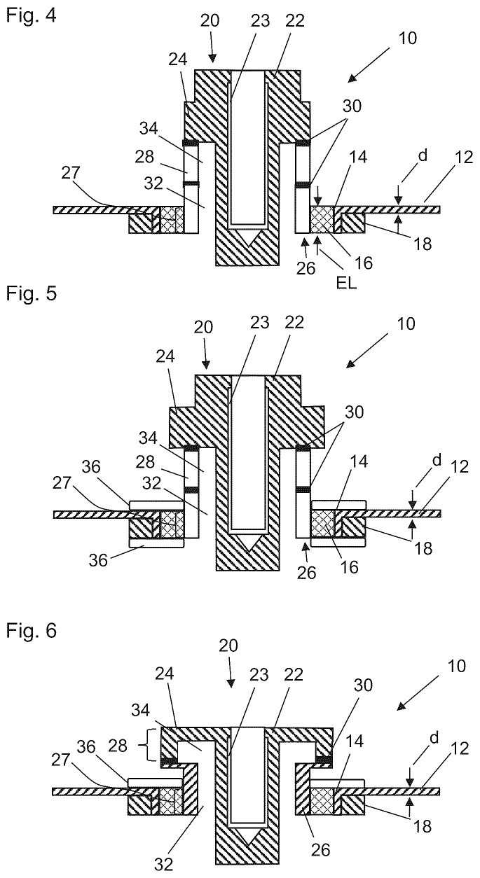

FIG. 4: a fourth embodiment of the bushing in a schematic sectional view from the side,

FIG. 5: a fifth embodiment of the bushing in a schematic sectional view from the side,

FIG. 6: a sixth embodiment of the bushing in a schematic sectional view from the side,

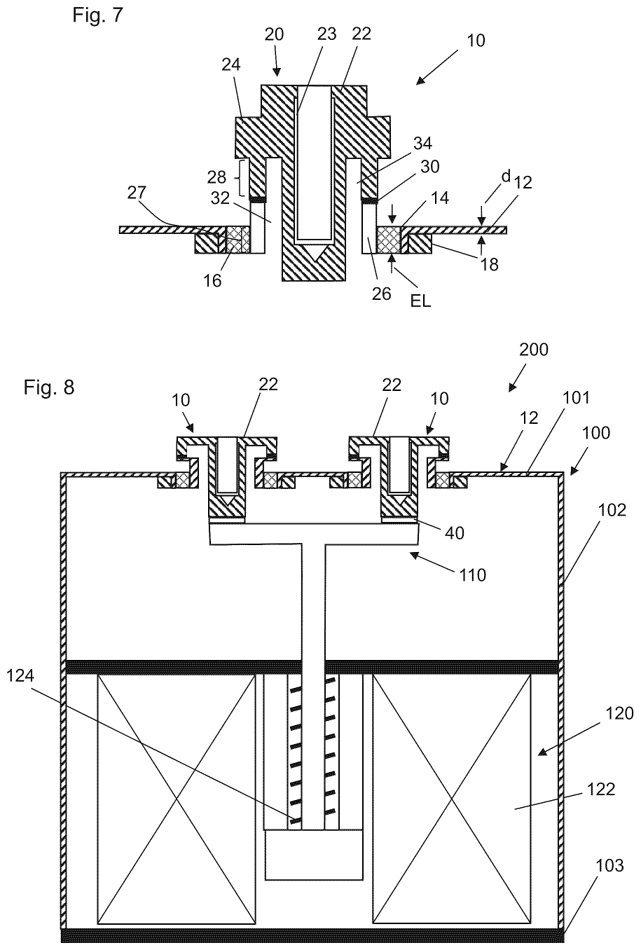

FIG. 7: a seventh embodiment of the bushing in a schematic sectional view from the side, and

FIG. 8: an exemplary embodiment of a relay having two bushings according to the invention in accordance with the sixth embodiment in a schematic sectional view from the side.

FIG. 1 shows a first embodiment of a bushing 10 having a connection terminal 22. The bushing 10 comprises a thin-walled housing part 12 with a through-opening 14 therein, the housing part having a material thickness or a thickness d in the vicinity of the through-opening 14. The material of the housing part 12 is bent by 90° at the through-opening 14. The bent portion of the housing part 12 is reinforced and supported by means of a reinforcing component 18. A connection terminal assembly 20 is fed through this through-opening 14 and is held therein by a fixing material 16. The fixing material 16 hermitically seals the connection terminal assembly 20 against the wall formations of the through-opening 14, so that the through-opening 14 is hermetically closed off. As a result of the bending of the material of the housing part 12, a glazing length EL significantly larger than the thickness d of the housing part 12 is provided for the fixing material 16.

The connection terminal assembly 20 comprises a connection terminal 22 and a pipe lead 26. In the exemplary embodiment shown, a longitudinal axis of the connection terminal 22 runs coaxially with a longitudinal axis of the pipe lead 26, and the pipe lead 26 surrounds part of the connection terminal 22. The fixing material 16 for sealing the connection terminal assembly 20 is arranged between an outer wall of a sleeve portion 27 of the pipe lead 26 and an inner wall of the through-opening 14, and a first gap 32 is present between an inner wall of the sleeve portion 27 and the connection terminal 22. As can be seen in the illustration in FIG. 1, the sleeve portion 27 is thus the portion of the pipe lead 26 that is arranged within the through-opening 14, directly adjacent to the fixing material 16.

In the first embodiment in FIG. 1, the pipe lead 26 has a portion of reduced thickness, which serves as a flexible element 28. In the portion of reduced thickness, the outside diameter of the pipe lead 26 remains unchanged; to reduce the thickness, only the inside diameter is reduced, whereby the wall thickness of the pipe lead 26 and thus the thickness of the pipe lead is reduced in this portion. As a result, a second gap 34 between the flexible element 28 and a cylindrical pin portion of the connection terminal 22 is larger than the first gap 32. Furthermore, the reduced thickness increases the flexibility of the pipe lead 26, so that the flexible element 28 formed can be short in comparison with known bushings having pipe leads and nevertheless can compensate, by elastic deformation, a change in the dimensions of the connection terminal 22 that is caused by temperature fluctuations.

At an upper end, the connection terminal 22 has a collar 24, which in the exemplary embodiment of FIG. 1 is in the form of two steps, in each of which a diameter of the cylindrical connection terminal 22 is enlarged. The connection terminal 22 also has a threaded bore 23 on its top side. The threaded bore 23 is in particular designed to establish a connection to an electrical supply line (not shown), the supply line being screwed to the connection terminal 22. Of course, in other embodiments other connection means can also be provided instead of the threaded bore 23 or connection means can be dispensed with, so that the connection terminal 22 has, for example, a flat face on its top side, which flat face can be connected to an electrical supply line by means of soldering or welding, for example.

In the first embodiment shown in FIG. 1, the flexible element 28 formed by the region of reduced wall thickness of the pipe lead 26 is connected to a side wall of the first step of the collar 24 of the connection terminal 22. Accordingly, the outside diameter of the first step of the collar 24 is smaller than the inside diameter of the fixing material 16. Furthermore, in the example shown the outside diameter of the second, larger step of the collar is smaller than the inside diameter of the through-opening 14. However, in other embodiment variants, this diameter could also be selected to be larger than the diameter of the through-opening 14. In the example shown, the connection is established by means of a solder connection 30, but of course other connection methods such as welding can also be used. The connection between the flexible element 28 and the collar 24 is likewise hermetically tight, so that the bushing 10 as a whole hermetically tightly seals the through-opening 14 of the housing part 12.

The part of the flexible element 28 that lies between the collar 24 and the sleeve portion 27 is configured and designed to elastically deform when force is applied, with the first gap 32 and the second gap 34 providing the space needed for this purpose. In this way, it is possible to absorb force occurring due to thermal expansion of the connection terminal 22 by means of an elastic shape change of the flexible element 28, in particular without a damaging application of force to the fixing material 16. Such thermal expansion can occur in particular when the connection terminal 22 carries large electric currents and is heated due to the electrical resistance present.

Advantageously, the wall thickness of the pipe lead 26 is not reduced in the sleeve portion 27, so that the pipe lead 26, the fixing material 16 and the housing part 12 can form a pressure glazing, in the case of which the coefficient of thermal expansion of the housing part 12 and of the reinforcing component 18 is selected to be greater than the coefficient of thermal expansion of the fixing material 16. As a result, after the glazing with the fixing material 16, the housing part 12 and the reinforcing component 18 contract more greatly than the fixing material 16 and thus exert a pressure on the fixing material 16. The pipe lead 26 having the larger wall thickness in the region of the sleeve portion 27 can develop the necessary counterpressure, while at the same time the flexible element 28 has the necessary elasticity for absorbing thermal expansion of the connection terminal 22.

The connection terminal 22 of the first exemplary embodiment in FIG. 1 is made of a first material, and the pipe lead 26 is made of a second material. This allows the material properties to be optimally selected for each of the two parts of the connection terminal assembly 20. In particular, a material having low electrical resistance can be selected for the connection terminal 22, and a rigid material having a large modulus of elasticity can be selected for the pipe lead 26 and in particular for its sleeve portion 27.

FIG. 2 shows a second exemplary embodiment of a bushing 10. In contrast to the first embodiment shown in FIG. 1, the pipe lead 26 is of a two-piece design, so that the sleeve portion 27 and the flexible element 28 are composed of two parts and are connected to each other by means of a connection 30, which, for example, is in the form a solder connection or weld connection. This makes it possible to produce the portion of the pipe lead 26 that serves as the flexible element 28 from a third material and to produce only the sleeve portion 27 from the second material. In this case, the third material is preferably selected such that it has a smaller modulus of elasticity than the second material and therefore can exhibit elastic deformation even when only a small force is applied.

In contrast to the first exemplary embodiment in FIG. 1, the material of the housing component 12 is not bent in the region of the through-opening 14, so that the fixing material 16 directly touches the reinforcing component 18. However, it is of course also possible in this exemplary embodiment to bend the material of the housing component 12 as in FIG. 1 and to support the same by means of the reinforcing component 18, so that fixing material 16 is connected, over the entire glazing length EL, to the inner wall formation of the through-opening 14, which inner wall formation is formed by the material of the housing component 12.

FIG. 3 shows a third exemplary embodiment of a bushing 10. As already described with reference to FIG. 1, the bushing 10 has a housing part 12 having a through-opening 14, through which a connection terminal assembly 20 having a connection terminal 22 and having a pipe lead 26 is fed. The connection terminal assembly is held in the through-opening 14 by means of a fixing material 16 and hermetically seals this through-opening.

Like in the first two embodiments in FIGS. 1 and 2, the connection terminal 22 has a collar 24 on one side, but here the collar is of a single-step design and is flush with one of the end faces of the connection terminal 22. A threaded bore 23 allowing threaded connection to an electrical supply line is again provided in this end face.

In the third exemplary embodiment in FIG. 3, the pipe lead 26 is formed by a coated sheet-metal part which comprises a metal sheet 38 with a coating 39 applied on one side. The sheet-metal part is essentially tubular and surrounds a cylindrical pin portion of the connection terminal 22, and a longitudinal axis of the pipe lead 26 runs coaxially with a longitudinal axis of the connection terminal 22. The sheet-metal part forms, at a first end, a sleeve region 27 having increased thickness and, at a second end, a flange. The sheet-metal part is designed such that the coating 39 faces inward toward the cylindrical pin portion of the connection terminal 22 and the uncoated side of the sheet-metal part accordingly faces outward. The sleeve region 27 is obtained by folding the sheet-metal part once or multiple times. In the process, the sheet-metal part is shaped such that the coating 39 of the metal sheet 38 is folded onto itself and thus lies inside. Accordingly, in the sleeve region 27 the uncoated side of the metal sheet 38 faces toward the fixing material 16. The flange is likewise obtained by shaping the sheet-metal part, in which case the coating 39 of the metal sheet 38 faces toward the collar 24 of the connection terminal 22 and is connected thereto by means of a connection 30, which, for example, is in the form of a solder connection. In order to provide the largest possible area for the connection 30 to the flange, an outside diameter of the collar is preferably selected to be larger than an inside diameter of the fixing material 16, as shown. In the exemplary embodiment shown in FIG. 3, the diameter of the collar 24 is selected to be smaller than the inside diameter of the through-opening 14. However, to further enlarge the connection area, the outside diameter of the collar 24 can also be selected to be larger than the inside diameter of the through-opening 14.

Between the flange and the sleeve region 27, the sheet-metal part is not folded and forms a portion there which has a smaller thickness than the sleeve region 27 and which serves as a flexible element 28. As a result, a first gap 32 between the sleeve region 27 and the cylindrical pin portion of the connection terminal 22 is smaller than a second gap 34 between the flexible element 28 and the cylindrical pin portion of the connection terminal 22.

FIG. 4 shows a fourth exemplary embodiment of a bushing 10. The bushing 10 again has a housing part 12 having a through-opening 14, through which a connection terminal assembly 20 having a connection terminal 22 and having a pipe lead 26 is fed. The connection terminal assembly is held in the through-opening 14 by means of a fixing material 16 and hermetically seals this through-opening.

Like in the first two embodiments in FIGS. 1 and 2, the connection terminal 22 has a collar 24 on one side, the collar likewise being of a multi-step design here, wherein, proceeding from a bottom side opposite from the top side having the threaded bore 23, the collar 24 has a first step and a second step, the diameter of the first step being larger than the diameter of the second step. However, in other embodiments it would of course also be possible to design the collar 24 differently, for example with only one step which is flush with the top side of the connection terminal 22.

On a bottom side of the collar 24, the pipe lead 26 is connected to the collar 24 by means of a connection 30, which, for example, is in the form of a solder connection. The pipe lead 26 is of a two-piece design here, wherein a sleeve portion 27 facing the fixing material 16 is made of the second material and a part serving as a flexible element 28 is made of a third material having a smaller modulus of elasticity than the second material. In the example shown, the two parts of the pipe lead 26 are likewise connected by means of a connection 30, which, for example, is in the form of a solder connection. The pipe lead 26 is arranged such that the flexible element 28 faces the collar 24. The pipe lead 26 as a whole is essentially cylindrical and surrounds a cylindrical pin portion of the connection terminal 22 such that the longitudinal axis of the pipe lead 26 runs coaxially with a longitudinal axis of the connection terminal 22. The dimensions of the collar 24 and of the pipe lead 26 are selected here in such a way that the outside diameter of the pipe lead 26 corresponds to the larger diameter of the collar 24 and thus the two parts transition into each other without a step.

FIG. 5 shows a fifth exemplary embodiment of the bushing 10, this bushing being similar to the fourth exemplary embodiment in FIG. 4. In contrast to the fourth exemplary embodiment, the diameter of the pipe lead 26 is smaller than the diameter of the collar 24. Furthermore, to improve the dielectric strength of the bushing 10, an additional insulation material 36 is provided, which here is in the form of two insulation disks. A first insulation disk covers a top side of the fixing material 16 and an adjacent part of the top side of the housing part 12. A second insulation disk covers a bottom side of the fixing material 16 and an adjacent part of the bottom side of the housing part 12. As a result of the arranged insulation material 36, in particular a creepage distance between the connection terminal assembly 20 and the housing part 12 is increased, so that the dielectric strength of the bushing 10 is improved. Instead of insulation disks, the insulation material 36 could also be applied, for example, in the form of an insulating coating. Furthermore, arranging the insulation material 36 only on one side, for example the top side, of the bushing 10 can be sufficient, depending on the use.

FIG. 6 shows a sixth exemplary embodiment of a bushing 10. The bushing 10 again has a housing part 12 having a through-opening 14, through which a connection terminal assembly 20 having a connection terminal 22 and having a pipe lead 26 is fed. The connection terminal assembly 20 is held in the through-opening 14 by means of a fixing material 16 and hermetically seals this through-opening.

Here, the connection terminal 22 has a collar 24 flush with a top side having a threaded bore 23, and a sleeve-like portion of the connection terminal 22 adjoins a bottom side of the collar 24 facing the through-opening 14, said sleeve-like portion serving as a flexible element 28. In this example, the outside diameter of the sleeve-like portion corresponds to the outside diameter of the collar 24, but the outside diameter can also, in deviation therefrom, be selected to be smaller. Furthermore, in the exemplary embodiment shown in FIG. 6, the outside diameter of the collar 24 is larger than the inside diameter of the fixing material 16 and smaller than the inside diameter of the through-opening 14. However, the outside diameter of the collar 24 could alternatively also be selected to be larger than the inside diameter of the through-opening 14.

The sleeve-like portion serves as a flexible element 28 and is connected to a pipe lead 26 by means of a connection 30, which, for example, is in the form of a solder connection. The pipe lead 26 comprises a sleeve portion 27, which adjoins the fixing material 16. A first gap 32 is present between the sleeve portion 27, which surrounds a cylindrical pin portion of the connection terminal 22, and the connection terminal 22. In the embodiment shown in FIG. 6, the sleeve portion 27 is extended upward and expands to form a connection flange at an end facing the collar 24. At the connection flange, the pipe lead 26 is connected to the flexible element 28 of the connection terminal 22. The pipe lead 26 is made of a second material, which has a larger modulus of elasticity than a first material of which the connection terminal 22 is made. Accordingly, forces occurring in the event of a thermal expansion of the connection terminal 22 are absorbed by means of an elastic shape change of the flexible element 28 of the connection terminal 22. Advantageously, as a result no force caused by the thermal expansion is transferred by means of the pipe sleeve 26 and in particular the sleeve portion 27 thereof to the fixing material 16, or such transfer is at least reduced to a harmless level.

The sleeve-like portion of the connection terminal 22 serving as the flexible element 28 surrounds the cylindrical pin portion of the connection terminal 22, and a longitudinal axis of the sleeve-like portion is concentric with a longitudinal axis of the cylindrical pin portion, and a second gap 34 is present between an inner face of the sleeve-like portion or the flexible element 28 formed by the sleeve-like portion and the cylindrical pin portion.

FIG. 7 shows a seventh exemplary embodiment of a bushing 10, wherein, similarly to the sixth exemplary embodiment in FIG. 6, a sleeve-like portion of the connection terminal 22 is designed as a flexible element 28.

In contrast to the embodiment in FIG. 6, here the portion of the connection terminal 22 serving as the flexible element 28 has a smaller outside diameter than the collar 24 and, like in the exemplary embodiments in FIGS. 4 and 5, the collar 24 is of a multi-step design. Furthermore, here the pipe lead 26 does not have a region of enlarged diameter serving as a connection flange. In the example shown, the outside and inside diameters of the pipe lead 26 and of the flexible element 28 are identical. Since the first material of the connection terminal 22 and thus of the flexible element 28 formed integrally therewith has a smaller modulus of elasticity than the second material of the pipe lead 26, forces occurring due to thermal expansion of the connection terminal 22 are absorbed by means of elastic deformation of the flexible element 28 and the shape of the pipe lead 26 remains essentially unchanged.

FIG. 8 shows an example of a relay 200, which, for example, is in the form of a high-power relay for an electric vehicle. The relay 200 comprises a housing 100 having a cup-like housing part 12. The housing part 12 has a base 101 and a side wall 102. The housing part 12 is joined to a cover 103 to form the housing 100. The housing part 12 comprises two electrical bushings 10, which are arranged in the base 101 and which have connection terminals 22 to which a circuit to be switched by the relay 200 can be connected. For example, electrical connectors can be screwed to the connection terminals 22 for this purpose. In the example shown in FIG. 8, the bushings 10 are designed as described with reference to FIG. 6. However, other of the bushings 10 described herein can of course also be used.

A contacting device 110 is arranged in the interior of the housing 100, the contacting device being designed such that, in a first position, the contacting device electrically connects the two connection terminals 22 so that current flow is possible and, in a second position, the contacting device electrically disconnects the two connection terminals 22 so that current flow is not possible. As shown in the illustration in FIG. 8, the connection terminals 22 can have, on the end face thereof facing the contacting device 110, a contact coating 40 made of a contact material. The contact material, for example silver or a silver-copper or silver-nickel alloy, is resistant to oxidation and reduces the electrical contact resistance between each connection terminal 22 and the contacting device 110.

To transfer the contacting device from one position into the other, in the exemplary embodiment shown in FIG. 8 an actuator 120 is provided, which is in the form of an electromagnetic actuator. For electrical contacting of the actuator 120, the housing 100 has additional electrical bushings, which are not visible in the sectional illustration in FIG. 6.

By means of an electromagnet 122 of the actuator 120, for example the contacting device 110 can then be brought into the first position when the electromagnet 122 is energized, so that electric current can flow between the two connection terminals 22. If the energizing of the electromagnet 122 is ended, for example the contacting device 110 can be brought into the second position by means of a spring 124, so that current flow between the two connection terminals 22 is no longer possible. To quickly quench an arc that may occur as the contacting device 110 is disconnected from the connection terminals 22, the interior of the housing 100 may be filled with a so-called quenching gas. Since the bushings 10 according to the invention are hermetically sealed, the quenching gas cannot escape from the housing 100.

In addition to the actuator 120, a further actuation device for moving the contacting device 110 can be provided in the relay 200. For example, a pyrotechnical device can be provided (not shown in FIG. 8) which, when an igniter is energized, triggers an explosive charge, which then quickly transfers the contacting device 110 into the second position, in the case of which the connection terminals 22 are electrically disconnected from each other.

The claims are not limited to the exemplary embodiments described herein. In particular, a large number of modifications are possible in which individual features of the exemplary embodiments described herein are combined with one another.

### LIST OF REFERENCE SIGNS

10 Bushing
12 Housing part
14 Through-opening
16 Fixing material
18 Reinforcing component
20 Connection terminal assembly
22 Connection terminal
23 Threaded bore
24 Collar
26 Pipe lead
27 Sleeve portion
28 Flexible element
30 Solder connection
32 First gap
34 Second gap
36 Insulation material
38 Metal sheet
39 Coating
40 Contact coating
100 Housing
101 Base
102 Side wall
103 Cover
110 Contacting device
120 Actuator
122 Electromagnet
124 Spring
200 Relay
EL Glazing length
d Thickness of housing component
D Thickness of reinforcing component

1. A bushing having a connection terminal, for a high-power relay, the bushing comprising
a housing part, which has a through-opening, and a connection terminal assembly, which is inserted through the through-opening and which is sealed against the through-opening by means of a fixing material, wherein the bushing has a reinforcing component, which reinforces the housing part in the region of the through-opening, and a glazing length of the fixing material is larger than the thickness (d) of the housing part,
wherein
the connection terminal assembly comprises a connection terminal made of a first material and a pipe lead made of a second material, wherein the pipe lead surrounds at least part of the connection terminal and the fixing material is arranged between an outer wall of a sleeve portion of the pipe lead and an inner wall of the through-opening in order to seal the connection terminal assembly,
wherein a first gap is present between an inner wall of the sleeve portion and the connection terminal, wherein
the connection terminal assembly also comprises a flexible element, by means of which the pipe lead is connected to the connection terminal, wherein the flexible element surrounds a pin portion of the connection terminal, and wherein a second gap is present between the pin portion of the connection terminal and the flexible element,
wherein
i) the flexible element is formed integrally with the pipe lead as a portion of the pipe lead with reduced thickness, or
ii) the flexible element is made of a third material, or
iii) the flexible element is formed integrally with the connection terminal.

2. The bushing of claim 1, wherein the reinforcing component extends an inner wall formation of the through-opening and provides the glazing length together with the housing part, or in that the housing part is bent in the region of the through-opening in order to form the inner wall formation of the through-opening over the entire glazing length, the bent portion of the housing part being supported by the reinforcing component.

3. The bushing of claim 1, wherein the material thickness of the housing part is selected in the range of 0.5 mm to 1 mm.

4. The bushing of claim 1, wherein the connection terminal has a collar and the flexible element according to variant i) or ii) is connected to the collar on a side of the collar facing the through-opening, or in that, in the case of integral formation with pipe lead according to variant iii), the portion of the connection terminal that forms the flexible element begins on the side of the collar facing the through-opening.

5. The bushing of claim 1, wherein the connection terminal has a collar and the flexible element according to variant i) or ii) is connected to the collar at a lateral face of the collar.

6. The bushing of claim 4, wherein the collar is arranged outside the through-opening.

7. The bushing of claim 1, wherein the pipe lead has a continuous or abrupt enlargement of the diameter on a side facing the flexible element, outside of the through-opening, and the pipe lead is connected to the flexible element in this region with enlarged diameter.

8. The bushing as claimed in claim 1, wherein the connection terminal has, on an outward-facing side, a threaded bore for fastening a connection line.

9. The bushing as claimed in claim 1, wherein the fixing material and an adjoining portion of the housing part are covered with an insulation material on a top side and/or on a bottom side of the bushing.

10. The bushing as claimed in of claim 1, wherein the bushing is designed as a pressure glazing, in the case of which a coefficient of thermal expansion of the housing part and/or of the reinforcing component is greater than a coefficient of thermal expansion of the fixing material.

11. The bushing of claim 1, wherein the first material has a smaller electrical resistance than the second material and/or in that the first material has a smaller modulus of elasticity than the second material.

12. The bushing of claim 1, wherein the third material according to variant ii) has a smaller modulus of elasticity than the second material.

13. The bushing of claim 1, wherein the first material is selected from a base nonferrous metal.

14. The bushing of claim 1, wherein an end face of the connection terminal is coated with a contact material in order to reduce the contact resistance and/or to reduce sparking.

15. The bushing of claim 1, wherein the pipe lead is designed as a sheet-metal part, wherein in the sleeve portion the thickness is enlarged, relative to the portion designed as the flexible element, by folding the sheet-metal part once or multiple times.

16. The bushing of claim 15, wherein the sheet-metal part is a sheet-metal part coated on one side and the sheet-metal part is folded and arranged such that a coated side of the sheet-metal part points toward a connection to the flexible element or to the connection terminal and an uncoated side of the sheet-metal part faces toward the fixing material.

17. The bushing of claim 1, wherein the second material is selected from a steel, or a steel alloy.

18. The bushing of claim 1, wherein the fixing material is selected from a glass, a glass ceramic, or a ceramic.

19. The bushing of claim 18, wherein the glass is selected from a borosilicate glass, a sodium barium glass, an alkali glass, a silicate glass or a soda glass.

20. The bushing of claim 1, wherein the connection terminal assembly comprises an additional flexible element connected to the pipe lead, the flexible element and the additional flexible element being connected to the connection terminal or, in the case of integral formation, transitioning into the connection terminal on opposite sides with respect to the through-opening.

21. The bushing of claim 1, wherein the housing part is a cup-like housing part having a base and side walls.

22. A housing comprising a bushing of claim 1.

23. A relay comprising at least two bushings of claim 1 and a contacting device for establishing an electrical connection between the connection terminals of the two bushings.
